(19) United States
(12) Patent Application Publication
(10) Pub. No.: US 2021/0187825 A1
(43) Pub. Date: Jun. 24, 2021

(54) MULTIFILAMENT FEEDSTOCKS FOR FUSED DEPOSITION MODELING

(71) Applicant: Universal Fibers, Inc., Bristol, VA (US)

(72) Inventors: Ryan Matthew Besch, Johnson City, TN (US); Stuart P. Fairgrieve, Kidlington (GB); Brendan F. McSheehy, Jr., Abingdon, VA (US); Logan Michael Pensinger, Bristol, VA (US)

(21) Appl. No.: 17/126,187

(22) Filed: Dec. 18, 2020

Related U.S. Application Data
(60) Provisional application No. 62/951,098, filed on Dec. 20, 2019.

(51) Int. Cl. B29C 64/118; B29C 64/336

(52) U.S. Cl. CPC B29C 64/118; B33Y 10/00; B29C 64/336

(57) ABSTRACT

A substantially continuous, entwined filamentary feedstock for additive manufacturing processes and fused filament fabrication (“FFF”) equipment is provided. Generally, the entwined filamentary feedstocks may contain a plurality of filaments and comprise a diameter suited for use in FFF and three-dimensional printers. Typically, the entwined feedstocks may comprise at least one filament forming a core and one or more filaments entwined around this core.

### RELATED APPLICATIONS

This application claims the priority benefit under 35 U.S.C. § 119(e) of U.S. Provisional Patent Application Ser. No. 62/951,098 entitled “MULTIFILAMENT FEEDSTOCKS FOR FUSED DEPOSITION MODELING,” filed Dec. 20, 2019, the entire disclosure of which is incorporated herein by reference.

### BACKGROUND

### 1. Field of the Invention

The present invention is generally concerned with entwined filaments for use as feedstocks in additive manufacturing processes and fused filament fabrication (“FFF”) equipment.

### 2. Description of the Related Art

Additive manufacturing, alternatively referred to as three-dimensional (“3D”) printing, may be defined as any process in which a 3D object is created by building up successive layers of material in a cumulative manner to produce a desired 3D shape, usually under the control of a computer-aided design (“CAD”) system.

Additive manufacturing, according to ISO/ASTM 52900, presently encompasses the following seven generic technologies: (1) material extrusion; (2) vat photopolymerization; (3) material jetting; (4) binder jetting; (5) powder bed fusion; (6) directed energy deposition; and (7) sheet lamination.

One of the most common methods currently used in additive manufacturing is 3D printing via material extrusion, wherein a nozzle extrudes a semi-liquified material to build up successive object layers, each layer itself consisting of a series of adjacent “roads” of material side-by-side.

Material extrusion devices come in several forms, ranging from desktop models with enclosed build chambers of limited size, larger scale prototyping/production machines with larger enclosed build chambers, larger scale machines with open-ended build chambers allowing the production of objects with less limits on size, and open-area machines with no specific build chamber that may be used in the construction of objects of unlimited size.

The feedstock materials used in the above devices and processes generally come in two basic forms: (1) powder/pellets and (2) essentially continuous filaments. Generally, the powder/pellets are used in larger and/or open-area processes, such as Big Area Additive Manufacturing (“BAAM”).

The majority of extrusion-based additive manufacturing devices and processes are 3D printing devices and processes, which use feedstocks in the form of the essentially continuous filaments, the process being commonly referred to as Fused Filament Fabrication (“FFF”) or Fused Deposition Modeling (“FDM”).

3D printer filaments generally comprise a low diameter, usually between 0.5 mm and 3.0 mm. Such filaments, depending on the materials from which they are made, are reasonably flexible and robust, and may be supplied to the user in the form of reels spooled onto holders of a size capable of being easily mounted within or beside any size of 3D printer from desk-top models upwards. With these low diameter filaments, narrow roads are laid down by the extrusion head of the printer, which allows small objects to be accurately made, and/or any object to be made that contains fine details. The low diameter of these filaments also means that the material can be melted rapidly, and with low power input, in the heated extruder section of the 3D printer head.

There are, however, some disadvantages to the use of such low diameter filament feedstocks. When larger objects are to be 3D printed, the narrow roads being laid down mean that the time required to complete the print job can be excessive. Also, in the case of any object being 3D printed, there may be parts thereof which do not require fine detailing, and again the time taken to complete the print job will be longer than optimal.

The use of larger diameter monocomponent filaments in the partial or total 3D printing of objects is possible, but such feedstock has its own inherent features. The effect of increased filament diameter on the actual laying down of molten roads during the 3D printing process can be handled through the use of interchangeable individual printer nozzles of larger diameter or through the use of variable diameter printer nozzles. Storage and supply of such filaments, both in terms of delivery to users and of interfacing with standard FFF printers is more of a problem, in that such higher diameter filaments are difficult to wind onto a spool of an acceptably small size. Depending on the type of material being used to manufacture such feedstock, it may even be necessary to supply the material, both to user and to machine, in the form of straight rods of limited length rather than as continuous filament. A further problem is the increased time, and increased power requirements, needed to fully melt such feedstock prior to deposition of the molten roads onto the object being 3D printed.

Accordingly, there is a need in the art for filamentary feedstock materials for use in FFF-type 3D printing, which can provide the potential enhanced printing rates of large diameter monocomponent filaments but can also circumvent the problems of low flexibility and melt-processing disadvantages.

### SUMMARY

One or more embodiments generally concern a process for manufacturing a three-dimensional printed object. Generally, the process comprises: (a) providing a three-dimensional printer and (b) depositing an entwined filamentary feedstock into the three-dimensional printer. Furthermore, the entwined filamentary feedstock generally comprises: (i) a central core comprising a first filament and (ii) a second filament at least partially entwined on the central core. Additionally, the entwined filamentary feedstock has an average diameter of 0.5 to 20 mm.

One or more embodiments generally concern an entwined filamentary feedstock for an extrusion-based three-dimensional printing process. Generally, the entwined filamentary feedstock comprises: (i) a central core comprising a first filament and (ii) a second filament at least partially entwined on the central core. Additionally, the entwined filamentary feedstock has an average diameter of 0.5 to 20 mm.

One or more embodiments generally concern a process for producing an entwined filamentary feedstock for an extrusion-based three-dimensional printing process. Generally, the process comprises: (a) providing a first filament and a second filament and (b) entwining at least a portion of the second filament on the first filament to thereby form the entwined filamentary feedstock. The entwined filamentary feedstock comprises: (i) a central core comprising the first filament and (ii) the second filament at least partially entwined on the central core. Additionally, the entwined filamentary feedstock has an average diameter of 0.5 to 20 mm.

### DETAILED DESCRIPTION

The present invention is generally concerned with an entwined filamentary feedstock for additive manufacturing, such as the extrusion-based 3D printing method commonly referred to as Fused Filament Fabrication (“FFF”). Generally, the entwined filamentary feedstock comprises, consists essentially of, or consists of a plurality of filaments, such as a plurality of low diameter printer filaments and/or monofilaments, combined together in such a manner as to provide a substantially physically stable, substantially continuous, 3D printer feedstock. In certain embodiments, the entwined filament feedstock may comprise, consist essentially of, or consist of: (i) a single central core formed from a single monofilament and (ii) one or more printer filaments and/or monofilaments surrounding the central core. In such embodiments, the resulting filament feedstock may be in the form of a braided filament comprising the central core surrounded by a “sheath” formed from one or more printer filaments and/or monofilaments.

As discussed herein, the inventive entwined filamentary feedstock may be prepared by entwining together a plurality of printer filaments and/or monofilaments and optionally consolidating the filaments into a 3D printer feedstock via the application of energy and/or adhesive materials.

In various embodiments, the entwined filamentary feedstock of the present invention may comprise, consist essentially of, or consist of a plurality filaments, such as low diameter printer filaments and/or monofilaments. Generally, the low diameter printer filaments may comprise uniform material filaments or wires designed for use in a material extrusion 3D printing process. In one or more embodiments, the low diameter printer filaments may have average diameters of at least 0.1, 0.2, 0.3, 0.4, or 0.5 mm and/or not more than 10, 9, 8, 7, 6, 5, 4, or 3 mm. Additionally or alternatively, in certain embodiments, each of the low diameter printer filaments may have average diameters of not more than 3, 2, 1, 0.9, 0.8, 0.7, 0.6, 0.5, or 0.4 mm.

Generally, the monofilaments may comprise uniform material filaments designed for any end use. In one or more embodiments, the monofilaments may have average diameters of at least 0.01, 0.05, or 0.1 mm and/or not more than 10, 5, 4, 3, or 2 mm. Additionally or alternatively, in certain embodiments when the monofilament is used as the central core, the monofilament may have an average diameter of at least 0.01, 0.05, 0.1, 0.2, 0.3, 0.4, 0.5, 0.6, 0.7, 0.8, or 0.9 mm and/or not more than 10, 9, 8, 7, 6, 5, 4, 3, 2, 1.9, 1.8, 1.7, 1.6, 1.5, 1.4, 1.3, 1.2, or 1.1 mm.

In certain embodiments, the printer filaments and/or monofilaments may be entwined together and optionally consolidated through the application of energy thereto and/or through the treatment with adhesive materials to form a physically stable, continuous, entwined filamentary feedstock suitable for use in equipment and processes associated with extrusion-based 3D printing.

In various embodiments, the entwined filamentary feedstock may have an overall average diameter, which includes all of the diameters of the printer filaments and/or monofilaments therein, of at least 0.5, 1, 1.5, 2, 2.5, 3, 3.5, 4, 4.5, or 5 mm and/or not more than 50, 40, 30, 20, 15, 10, 9, 8, 7, or 6 mm.

In various embodiments, the entwined filamentary feedstocks may comprise at least 1, 25, 50, 60, 70, 80, 85, 90, 95, or 99 weight percent of one or more filaments, such as one or more printer filaments and/or monofilaments.

The filaments forming the entwined filamentary feedstocks, such as the printer filaments and/or monofilaments, may be formed from any suitable materials capable of being at least partially melted, extruded, and deposited using equipment and processes associated with extrusion-based 3D printing. Such materials include, but are not limited to, resins, metals, ceramic precursors, and thermoplastic polymers.

In various embodiments, the filaments forming the entwined filamentary feedstocks, such as the printer filaments and/or monofilaments, are at least partially or entirely formed with two or more materials. In certain embodiments, the printer filaments and/or monofilaments are at least partially or entirely formed with at least two materials selected from the group consisting of resins, metals, ceramic precursors, and thermoplastic polymers.

In various embodiments, the filaments forming the entwined filamentary feedstocks, such as the printer filaments and/or monofilaments, are at least partially or entirely formed with thermoplastic polymers. In certain embodiments, all of the printer filaments and/or monofilaments are formed from the same thermoplastic polymers. For example, all of the printer filaments and/or monofilaments may be formed from a polyamide (e.g., Nylon 6, Nylon 66, or Nylon 12). Alternatively, in certain embodiments, the printer filaments and/or monofilaments may be formed from different thermoplastic polymers. For instance, the inventive entwined filamentary feedstock may comprise printer filaments and/or monofilaments formed entirely from a polyamide (e.g., Nylon 6, Nylon 66, or Nylon 12) and printer filaments and/or monofilaments formed entirely from polypropylene.

In various embodiments, the printer filaments and/or monofilaments may comprise at least 25, 50, 75, 80, 85, 90, 95, or 99 weight percent of one or more thermoplastic polymers. The thermoplastic polymers may be selected from, but are not limited to, one or more of the polymers consisting of: polyolefins, styrenics, acrylics, polyesters, polyamides, polyarylene oxides, polyarylene sulfides, polyaryletherketones, liquid crystalline polymers (LCP), thermoplastic elastomers, fluoropolymers, and silicones. In certain embodiments, the printer filaments and/or monofilaments may be produced from a polyolefin (e.g., polyethylene or polypropylene), a polyester, a polyamide (e.g., Nylon 6, Nylon 66, or Nylon 12), an elastomer, or a combination thereof. Any or all of the thermoplastic polymers may be selected from one or more of the following classifications of materials: polymers derived from petrochemical resources, polymers derived from renewable resources, virgin polymers, recycled polymers, and polymers based on materials chemically recovered from recycled polymers. In one or more embodiments, the printer filaments and/or monofilaments can be produced by any conventional melt spinning process known in the art.

The printer filaments and/or monofilaments used in the manufacture of the filamentary feedstock of the present invention may be of any suitable cross-sectional shape including, but not limited to, round, oval, square, rectangular, polygonal, regular multilobal, or irregular multilobal. In certain embodiments, the printer filaments and/or monofilaments may comprise a round cross-sectional shape. In various embodiments, the printer filaments and/or monofilaments used in the manufacture of the filamentary feedstocks may all contain the same cross-sectional shape or may comprise two or more different cross-sectional shapes.

In various embodiments, the printer filaments and/or monofilaments used in the manufacture of the filamentary feedstock of the present invention may be of any suitable diameter. In certain embodiments, the printer filaments and/or monofilaments may have an average diameter of at least 0.1, 0.2, 0.3, 0.4, or 0.5 mm and/or not more than 10, 9, 8, 7, 6, 5, 4, 3, or 2 mm. The plurality of printer filaments and/or monofilaments used in the manufacture of the filamentary feedstocks may comprise individual printer filaments and/or monofilaments of the same diameter or may comprise individual printer filaments and/or monofilaments of two or more different diameters.

In various embodiments, the inventive feedstocks may comprise any suitable number of individual printer filaments and/or monofilaments. In one or more embodiments, the inventive feedstocks comprise at least 2, 3, 4, or 5 and/or not more than 50, 40, 30, 25, 20, 15, 10, 9, 8, 7, or 6 of individual printer filaments and/or monofilaments. In certain embodiments, the inventive feedstock comprises 3 to 6 individual printer filaments and/or monofilaments.

In various embodiments, the feedstocks of the present invention may contain other ingredients in the form of functional additives. Exemplary additives may be selected from, but are not limited to, one or more of the group consisting of: antioxidants, light stabilizers, metal deactivators, antimicrobials, anti statics, colorants, particulate fillers, fibrous fillers, flame retardants, electrically conductive materials, thermally conductive materials, lubricants, impact modifiers, nucleating agents, and crystallization suppression agents. In certain embodiments, the feedstocks may comprise at least 0.5, 1, 2, 3, 4, 5, 6, 7, 8, 9, or 10 weight percent and/or not more than 50, 45, 40, 35, 30, 25, 20, 15, 10, 9, 8, 7, 6, 5, 4, 3, 2, or 1 weight percent of one or more functional additives.

Generally, the individual printer filaments and/or monofilaments forming the filamentary feedstocks may be entwined using any conventional entwining process known in the art. In certain embodiments, the entwining process used in the manufacture of the filamentary feedstock may be selected from, but is not limited to, one or more of the following: twisting, interlacing, interweaving, knitting, plaiting, and braiding. Generally, in one or more embodiments, the filamentary feedstocks may be formed by braiding the individual printer filaments and/or monofilaments in a braiding machine, including those braiding machines known and used in the art.

In various embodiments, the filamentary feedstocks may be produced by twisting a plurality of the printer filaments and/or monofilaments. Generally, in certain embodiments, the twisting process may involve spiral twisting all of the printer filaments and/or monofilaments in one direction about a mutual center of the cross-section of the printer filaments and/or monofilaments. Typically, in certain embodiments, the twisting process may involve a spiral twist of a portion of the plurality of printer filaments and/or monofilaments in one direction and a spiral twist of another portion of the plurality of printer filaments and/or monofilaments in the opposite direction, both about a mutual center of the cross-section of the printer filaments and/or monofilaments.

Additionally or alternatively, in certain embodiments, the twisting process may involve a twist of a portion of the plurality of printer filaments and/or monofilaments in one, or both, directions about a straight single printer filament or monofilament as a central core and a twist of another portion of the plurality of printer filaments and/or monofilaments in one, or both, directions about a straight portion of printer filaments and/or monofilaments as a central core.

In one or more embodiments, the resulting filamentary feedstock may comprise, consist essentially of, or consist of: (i) a single central core formed from a single monofilament and (ii) one or more printer filaments and/or additional monofilaments surrounding the central core (the “sheath” filaments). In certain embodiments, the “sheath” surrounding the central core may comprise 1, 2, 3, 4, 5, 6, or 7 individual printer filaments and/or monofilaments. In embodiments where a central core is present, the central core monofilament may have an average diameter of at least 0.01, 0.05, 0.1, 0.2, 0.3, 0.4, 0.5, 0.6, 0.7, 0.8, or 0.9 mm and/or not more than 10, 9, 8, 7, 6, 5, 4, 3, 2, 1.9, 1.8, 1.7, 1.6, 1.5, 1.4, 1.3, 1.2, or 1.1 mm. Additionally or alternatively, in one or more embodiments, each of the filaments (printer filaments and/or other monofilaments) forming the “sheath” surrounding the central core may have an average diameter of at least 0.1, 0.2, or 0.3 mm and/or not more than 3, 2, 1, 0.9, 0.8, 0.7, 0.6, 0.5, or 0.4 mm.

Furthermore, in the embodiments where a central core is present in the entwined filamentary feedstock, the central core and/or the sheath filaments surrounding the core may comprise at least one low melt binder filament. As used herein, a “low melt binder filament” refers to a filament that has a lower melting point relative to the other filaments forming the sheath and/or core. These low melt binder filaments are designed to at least partially melt at temperatures that will not melt the other filaments, which allows the at least partially melted filament to form a binder within the entwined filamentary feedstock. The low melt binder filaments may be formed from any of the thermoplastic polymers described herein and may have the average diameters described above regarding the printer filaments or monofilaments. In one or more embodiments, the low melt binder filament may exhibit a melting point that is at least 1, 5, 10, 15, 20, 25, 30, 35, 40, 45, or 50° C. lower than any of the filaments forming the entwined filamentary feedstock, including the central core and sheath.

In certain embodiments, the central core and/or the sheath surrounding the core may be formed entirely of this low melt binder filament. Alternatively, in certain embodiments, the central core and/or the sheath surrounding the core may be formed with the low melt binder filament and at least one other filament exhibiting a higher melting point. In such embodiments, the low melt binder filament may be compatible with this other filament and, in certain embodiments, be formed of the same polymer type (e.g., nylon 6 or nylon 66).

In one or more embodiments, the entwined filamentary feedstock, the central core, and/or the sheath may comprise at least 0.5, 1, 2, 3, 4, 5, 6, 7, 8, 9, 10, 15, 20, 25, 30, 35, 40, 45, 50, 55, 60, 65, 70, 75, 80, 85, 90, 95, or 99 weight percent of at least one low melt binder filament. Additionally or alternatively, in certain embodiments, the entwined filamentary feedstock, the central core, and/or the sheath may comprise not more than 99, 95, 90, 85, 80, 75, 70, 65, 60, 55, 50, 45, 40, 35, 30, 25, 20, 15, 10, or 5 weight percent of at least one low melt binder filament.

Generally, the entwining of the printer filaments and/or monofilaments forming the filamentary feedstock may be preceded by, accompanied by, or followed by an optional consolidation process for the filamentary feedstock. In various embodiments, the consolidation process may comprise an at least partial melting process and/or an adhesion treatment with one or more adhesive materials. During the melting process, at least a portion of the printer filaments and/or monofilaments may be at least partially melted so as to form an adhesive bond within the entwined filamentary feedstock.

The at least partial melting process may be carried out using an energy input and may comprise any conventional melting technique known in the art, such as, but not limited to, one or more of: contact heating, hot fluid heating, radiant heating, frictional heating, and laser beam heating. The process may be carried out at any suitable point in the manufacturing process, including before, during, and/or after the entwining process.

The treatment with an adhesive material may be carried out at any suitable point in the overall manufacturing process and, therefore, may comprise coating and/or impregnating: (1) any or all of the printer filaments and/or monofilaments prior to the entwining process, (2) any or all of the printer filaments and/or monofilaments during the entwining process, and/or (3) the entwined plurality of printer filaments and/or monofilaments subsequent to the entwining process. Furthermore, in certain embodiments after the entwining process and a previous adhesive treatment process, the entwined feedstock may be subjected to an additional adhesive treatment process to thereby overcoat the printer filaments and/or monofilaments with the adhesive material.

In various embodiments, the treatment with an adhesive material may involve an adhesive material in either liquefied or powdered form and may be carried out in any suitable manner including, but not limited to, one or more of: spraying, contact coating, dip coating, die coating, fluidized bed coating, and electrostatic deposition.

The adhesive material may be any suitable adhesive material including, but not limited to, one or more of the group consisting of: a thermoplastic polymer of the same type used to form at least one of the printer filaments and/or monofilaments; a thermoplastic polymer of a type different to the one forming the printer filaments and/or monofilaments; a hotmelt adhesive formulation; an energy-activated adhesive formulation; a thermoplastic elastomer; and a supramolecular polymer.

The adhesive material used in the consolidation of the entwined printer filaments and/or monofilaments may, in addition, contain one or more functional additives, selected from, but not limited to, the group consisting of: antioxidants, light stabilizers, metal deactivators, antimicrobials, anti statics, colorants, particulate fillers, fibrous fillers, flame retardants, lubricants, processing aids, impact modifiers, nucleating agents, and crystallization suppression agents.

In various embodiments, the inventive feedstocks may comprise at least 0.1, 0.5, 1, 2, 3, 4, 5, 6, 7, 8, 9, or 10 weight percent and/or not more than 50, 40, 30, 20, 10, 9, 8, 7, 6, 5, 4, 3, 2, or 1 weight percent of one or more adhesive materials.

Representative, but non-limiting, examples of embodiments of the present invention include the following disclosed entwined filamentary feedstocks; however, it should be noted that the following embodiments are not mutually exclusive to each other and may be combined in any combination as long as such combination does not contradict any feature of the disclosed embodiments.

In certain embodiments, the entwined filamentary feedstocks may comprise a plurality of printer filaments and/or monofilaments, wherein all of the printer filaments and/or monofilaments are formed from the same thermoplastic polymer (e.g., a polyamide).

In certain embodiments, the entwined filamentary feedstocks may comprise a plurality of printer filaments and/or monofilaments, wherein the printer filaments and/or monofilaments are formed from two or more different matrix thermoplastic polymers (e.g., a polyamide and a polyester).

In certain embodiments, the entwined filamentary feedstocks may comprise a plurality of printer filaments and/or monofilaments having the same average diameter.

In certain embodiments, the entwined filamentary feedstocks may comprise a plurality of printer filaments and/or monofilaments having two or more different average diameters.

In certain embodiments, the entwined filamentary feedstocks may comprise a plurality of printer filaments and/or monofilaments having the same cross-sectional shape.

In certain embodiments, the entwined filamentary feedstocks may comprise a plurality of printer filaments and/or monofilaments having two or more different cross-sectional shapes.

In certain embodiments, the entwined filamentary feedstocks may comprise a plurality of printer filaments and/or monofilaments, wherein the printer filaments and/or monofilaments are formed from a thermoplastic polymer having the same functional additive.

In certain embodiments, the entwined filamentary feedstocks may comprise a plurality of printer filaments and/or monofilaments, wherein the printer filaments and/or monofilaments are formed from two or more thermoplastic polymers having different functional additives.

In certain embodiments, the entwined filamentary feedstocks may comprise an adhesive material comprising a thermoplastic polymer of the same type that forms at least one of the printer filaments and/or monofilaments in the feedstock.

In certain embodiments, the entwined filamentary feedstocks may comprise an adhesive material comprising a thermoplastic polymer of the same type that forms at least one of the printer filaments and/or monofilaments in the feedstock; however, the thermoplastic polymer forming the adhesive material has a different melt viscosity and/or molecular weight relative to the thermoplastic polymer forming the printer filaments and/or monofilaments.

In certain embodiments, the entwined filamentary feedstocks may comprise an adhesive material comprising a thermoplastic polymer that is different from any of the thermoplastic polymers that form the printer filaments and/or monofilaments in the feedstock.

In certain embodiments, the entwined filamentary feedstocks may comprise an adhesive material comprising a thermoplastic polymer that is different from any of the thermoplastic polymers that form the printer filaments and/or monofilaments in the feedstock, wherein the thermoplastic polymer forming the adhesive material has a different melt viscosity and/or molecular weight relative to the thermoplastic polymers forming the printer filaments and/or monofilaments.

In certain embodiments, the entwined filamentary feedstocks may comprise an adhesive material comprising a hotmelt adhesive, wherein the hotmelt adhesive is formed of a thermoplastic polymer of the same type that forms at least one of the printer filaments and/or monofilaments in the feedstock.

In certain embodiments, the entwined filamentary feedstocks may comprise an adhesive material comprising a hotmelt adhesive, wherein the hotmelt adhesive is formed of a thermoplastic polymer that is different from the thermoplastic polymers that form the printer filaments and/or monofilaments in the feedstock.

In certain embodiments, the entwined filamentary feedstocks may comprise an adhesive material comprising an energy-activated adhesive, wherein the energy-activated adhesive is formed of a thermoplastic polymer of the same type that forms at least one of the printer filaments and/or monofilaments in the feedstock.

In certain embodiments, the entwined filamentary feedstocks may comprise an adhesive material comprising an energy-activated adhesive, wherein the energy-activated adhesive is formed of a thermoplastic polymer that is different from the thermoplastic polymers that form the printer filaments and/or monofilaments in the feedstock.

In certain embodiments, the entwined filamentary feedstocks may comprise an adhesive material comprising a thermoplastic elastomer, wherein the thermoplastic elastomer is formed of a thermoplastic polymer of the same type that forms at least one of the printer filaments and/or monofilaments in the feedstock.

In certain embodiments, the entwined filamentary feedstocks may comprise an adhesive material comprising a thermoplastic elastomer, wherein the thermoplastic elastomer is formed of a thermoplastic polymer that is different from the thermoplastic polymers that form the printer filaments and/or monofilaments in the feedstock.

In certain embodiments, the entwined filamentary feedstocks may comprise an adhesive material comprising at least one supramolecular polymer.

In certain embodiments, the entwined filamentary feedstocks may comprise an adhesive material comprising one or more functional additives, wherein at least one of the functional additives are also present in at least one of the printer filaments and/or monofilaments in the feedstock.

In certain embodiments, the entwined filamentary feedstocks may comprise an adhesive material comprising one or more functional additives, wherein the functional additives are not present in any of the printer filaments and/or monofilaments in the feedstock.

In certain embodiments, the entwined filamentary feedstocks do not contain an adhesive material.

While not wishing to be constrained by any specific theories, it may be demonstrated that certain of the above embodiments, alone or in combination, can result in specific useful properties being imparted to the entwined filamentary feedstocks of the present invention, which constitute improvements over those exhibited by monocomponent FFF 3D printer filaments of equivalent overall diameter. Such improvements may include, but are not limited to, one or more of the following: (1) increased flexibility; (2) ability to incorporate higher filler loadings; (3) faster and more complete melting; and/or (4) increased adhesion between roads in the X-Y plane and between layers in the Z direction of the 3D build.

This invention can be further illustrated by the following examples of embodiments thereof, although it will be understood that these examples are included merely for the purposes of illustration and are not intended to limit the scope of the invention unless otherwise specifically indicated.

### EXAMPLES

### Example 1

An entwined filamentary feedstock in the form of a braided filament was produced. A melt-spun nylon 6/66 monofilament with a round cross-sectional shape and an average diameter of about 1.0 mm was twisted with a single melt-spun nylon 12 monofilament with a round-cross sectional shape and an average diameter of 0.3 mm. The twisting was conducted by a braider machine. The nylon 6/66 monofilament formed the central core of the resulting braided filament, while the nylon 12 monofilament formed the surrounded sheath. The resulting braided filament had an average diameter of about 2.0 mm.

### DEFINITIONS

It should be understood that the following is not intended to be an exclusive list of defined terms. Other definitions may be provided in the foregoing description, such as, for example, when accompanying the use of a defined term in context.

As used herein, the terms “a,” “an,” and “the” mean one or more.

As used herein, the term “and/or,” when used in a list of two or more items, means that any one of the listed items can be employed by itself or any combination of two or more of the listed items can be employed. For example, if a composition is described as containing components A, B, and/or C, the composition can contain A alone; B alone; C alone; A and B in combination; A and C in combination, B and C in combination; or A, B, and C in combination.

As used herein, the terms “comprising,” “comprises,” and “comprise” are open-ended transition terms used to transition from a subject recited before the term to one or more elements recited after the term, where the element or elements listed after the transition term are not necessarily the only elements that make up the subject.

As used herein, the terms “having,” “has,” and “have” have the same open-ended meaning as “comprising,” “comprises,” and “comprise” provided above.

As used herein, the terms “including,” “include,” and “included” have the same open-ended meaning as “comprising,” “comprises,” and “comprise” provided above.

### NUMERICAL RANGES

The present description uses numerical ranges to quantify certain parameters relating to the invention. It should be understood that when numerical ranges are provided, such ranges are to be construed as providing literal support for claim limitations that only recite the lower value of the range as well as claim limitations that only recite the upper value of the range. For example, a disclosed numerical range of 10 to 100 provides literal support for a claim reciting “greater than 10” (with no upper bounds) and a claim reciting “less than 100” (with no lower bounds).

### CLAIMS NOT LIMITED TO DISCLOSED EMBODIMENTS

The preferred forms of the invention described above are to be used as illustration only, and should not be used in a limiting sense to interpret the scope of the present invention. Modifications to the exemplary embodiments, set forth above, could be readily made by those skilled in the art without departing from the spirit of the present invention.

The inventors hereby state their intent to rely on the Doctrine of Equivalents to determine and assess the reasonably fair scope of the present invention as it pertains to any apparatus not materially departing from but outside the literal scope of the invention as set forth in the following claims.

What is claimed is:

1. A process for manufacturing a three-dimensional printed object comprising:
(a) providing a three-dimensional printer; and
(b) depositing an entwined filamentary feedstock into said three-dimensional printer, wherein said entwined filamentary feedstock comprises—
(i) a central core comprising a first filament, and
(ii) a second filament at least partially entwined on said central core,
wherein said entwined filamentary feedstock has an average diameter of 0.5 to 20 mm.

2. The process according to claim 1, wherein said entwined filamentary feedstock has an average diameter of 1 to 10mm.

3. The process according to claim 1, wherein said entwined filamentary feedstock has an average diameter of 1 to 7 mm.

4. The process according to claim 1, wherein said central core consists of said first filament, wherein said first filament has an average diameter of 0.1 to 6 mm.

5. The process according to claim 4, wherein said second filament has an average diameter of 0.1 to 2 mm.

6. The process according to claim 5, wherein said entwined filamentary feedstock further comprises a third filament at least partially entwined on said central core, wherein said third filament has an average diameter of 0.1 to 2 mm.

7. The process according to claim 1, wherein said first filament and said second filament are formed from at least one thermoplastic polymer, wherein said thermoplastic polymer comprises a polyolefin, a styrenic, an acrylic, a polyester, a polyamide, a polyarylene oxide, a polyarylene sulfide, a polyaryletherketone, a liquid crystalline polymer, a thermoplastic elastomer, a fluoropolymer, a silicone, or a combination thereof.

8. The process according to claim 1, wherein said entwined filamentary feedstock is a consolidated entwined filamentary feedstock comprising an at least partially melted first filament, an at least partially melted second filament, an adhesive, or a combination thereof.

9. The process according to claim 1, further comprising forming a three-dimensional object with said entwined filamentary feedstock.

10. An entwined filamentary feedstock for an extrusion-based three-dimensional printing process, said entwined filamentary feedstock comprising:
(a) a central core comprising a first filament, and
(b) a second filament at least partially entwined on said central core,
wherein said entwined filamentary feedstock has an average diameter of 0.5 to 20 mm.

11. The entwined filamentary feedstock according to claim 10, wherein said entwined filamentary feedstock has an average diameter of 1 to 7 mm.

12. The entwined filamentary feedstock according to claim 10, wherein said central core consists of said first filament, wherein said first filament has an average diameter of 0.1 to 6 mm.

13. The entwined filamentary feedstock according to claim 12, wherein said second filament has an average diameter of 0.1 to 2 mm.

14. The entwined filamentary feedstock according to claim 13, wherein said entwined filamentary feedstock further comprises a third filament at least partially entwined on said central core, wherein said third filament has an average diameter of 0.1 to 2 mm.

15. The entwined filamentary feedstock according to claim 10, wherein said first filament and said second filament are formed from at least one thermoplastic polymer, wherein said thermoplastic polymer comprises a polyolefin, a styrenic, an acrylic, a polyester, a polyamide, a polyarylene oxide, a polyarylene sulfide, a polyaryletherketone, a liquid crystalline polymer, a thermoplastic elastomer, a fluoropolymer, a silicone, or a combination thereof.

16. The entwined filamentary feedstock according to claim 10, wherein said entwined filamentary feedstock is a consolidated entwined filamentary feedstock comprising an at least partially melted first filament, an at least partially melted second filament, an adhesive, or a combination thereof.

17. A process for producing an entwined filamentary feedstock, said process comprising:
(a) providing a first filament and a second filament;
(b) entwining at least a portion of said second filament on said first filament to thereby form said entwined filamentary feedstock, wherein said entwined filamentary feedstock comprises—
(i) a central core comprising said first filament, and
(ii) the second filament is at least partially entwined on said central core,
wherein said entwined filamentary feedstock has an average diameter of 0.5 to 20 mm.

18. The process according to claim 17, wherein said entwined filamentary feedstock comprises an average diameter of 1 to 7 mm,
wherein said first filament has an average diameter of 0.1 to 6 mm,
wherein said second filament has an average diameter of 0.1 to 2 mm, and
wherein said first filament and said second filament are formed from at least one thermoplastic polymer, wherein said thermoplastic polymer comprises a polyolefin, a styrenic, an acrylic, a polyester, a polyamide, a polyarylene oxide, a polyarylene sulfide, a polyaryletherketone, a liquid crystalline polymer, a thermoplastic elastomer, a fluoropolymer, a silicone, or a combination thereof.

19. The process according to claim 17, wherein said entwining comprises a twisting process.

20. The process according to claim 17, further comprising consolidating said entwined filamentary feedstock to thereby formed a consolidated entwined filamentary feedstock, wherein said consolidating comprises at least partially melting said first filament, at least partially melting said second filament, applying an adhesive material to said entwined filamentary feedstock, or a combination thereof.
